(19) United States
(12) Patent Application Publication
(10) Pub. No.: US 2013/0262230 A1
(43) Pub. Date: Oct. 3, 2013

(54) Providing Contextual Information to Search Results Targets

(71) Applicants: Simon P. King, Berkeley, CA (US); Rahul Nair, Daly City, CA (US)

(72) Inventors: Simon P. King, Berkeley, CA (US); Rahul Nair, Daly City, CA (US)

(73) Assignee: MICROSOFT CORPORATION, Redmond, WA (US)

(21) Appl. No.: 13/434,547

(22) Filed: Mar. 29, 2012

(51) Int. Cl. G06F 17/30; G06Q 20/22; G06Q 30/02

(52) U.S. Cl. 705/14.54; 707/722; 707/728; 705/39; 707/E17.014

(57) ABSTRACT

According to the disclosed subject matter, various embodiments for generating a search results page that provides contextual information to an entity/target site associated with a search result are presented. In response to receiving a search query from a user, a set of search results is obtained. Each search result in the set of search results comprises a hyperlink to content at a target site. From the set of identified search results, a search results page is generated. The generated search results page includes at least one search result that is encoded with data for providing contextual information of the user's current query context to the corresponding target site upon user selection of the at least one search result. The generated search results page is then provided to the user in response to the search query.

### BACKGROUND

As search engines continue to personalize search results according to individual user preferences, content providers lose the ability to predict where a search result referencing the content provider's content will be displayed on a given search results page for a given query. In other words, the order of search results on a search results page for the exact same search query will be different between two users. Of course, given a large enough sample population, content providers could determine an average location for a specific search result (or results) in a search results page for a specific query, as well as statistical information. Nevertheless, as content providers try to increase their return on investment, it would be of great importance to know where a search result is actually located in a search results page in response to a specific query from a specific user.

### SUMMARY

According to at least one embodiment of the disclosed subject matter, a method for generating a search results page that provides contextual information of a user's current query context to a target site associated with a search result is presented. In operation, the method obtains a set of search results responsive to a search query from a user. Each search result in the set of search results comprises a hyperlink to content at a corresponding target site. A search results page is generated from the set of identified search results. With regard to the search results page, at least one search result in the search results page is encoded with data for providing contextual information of the user's current query context to the target site. The at least one search result is encoded such that the encoded data is delivered to the corresponding target site upon the user's selection of the at least one search result. The generated search results page is then provided to the user for display in response to the search query.

According to at least one alternative embodiment, a computer-implemented system for providing contextual information to a target site upon the selection of a search result referencing content hosted by the target site is presented. The system comprises at least a processor, a memory, and a network communication component. In executing the instructions stored in the memory, the system is configured to operate as follows, including: the system obtains a set of search results responsive to receiving a search query from a user. Each search result in the set of search results comprises a hyperlink to content at a target site. The set of search results is personalized according to the at least one preference of the user resulting in a rearranged set of search results. A search results page is generated from the rearranged set of search results. In generating the search results page, at least one search result in the search results page is encoded with data for providing contextual information of the user's current query context to the corresponding target site upon user selection of the at least one search result. The generated search results page is then provided to the user in response to the search query.

In yet another embodiment of the disclosed subject matter, a computer-readable medium bearing computer-executable instructions is presented. The instructions, when executed on a computer system comprising at least a processor and a memory, carry out a method for generating a search results page that includes at least one search result that provides contextual information of the user's current query context to target site associated with the search result. The method comprises the following steps, including: obtaining a set of search results responsive to receiving a search query from a user. Each search result in the set of search results comprises a hyperlink to content at a target site. The order of the search results are personalized according to the at least one preference of the user. A search results page is generated from the personalized set of search results. The generated search results page includes at least one search result that is encoded with data for providing contextual information of the user's current query context to the corresponding target site. The encoded data is delivered to the corresponding target source upon user selection of the at least one search result. The generated search results page is provided to the user in response to the search query.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 shows a diagram of an illustrative environment 100 in which contextual information can be provide to a target site by way of a search results page;

FIG. 2 is an illustrative diagram showing a sample search results page in which some of the search results displayed on the search results page have been encoded with data for delivering contextual information to the corresponding target site;

FIG. 3 is a diagram illustrating exemplary search results encoded with data for delivering contextual information to target sites;

FIG. 4 is a state diagram illustrating the interaction between a user via a user computer, the search engine , and a target site;

FIG. 5 shows a flow diagram 500, as executed on a search engine 110, for providing a search results page responsive to a search query from a user, the search results page including at least one search result encoded with data for providing contextual information to a corresponding target site; and

FIG. 6 is a block diagram illustrating a search engine 110 for providing search results encoded with data for providing contextual information surrounding the current query context of the user to target sites.

### DETAILED DESCRIPTION

For purposed of clarity, the use of the term “exemplary” in this document should be interpreted as serving as an illustration or example of something, and it should not be interpreted as an ideal and/or leading illustration of that thing.

As used herein, “hyperlink” is a reference to data/content at a target site. In some instances, when displayed on a Web browser on a user computer, a hyperlink is user actionable such that, upon activating the hyperlink (also referred to as a “link”), the referenced content replaces the current content in the browser. As those skilled in the art will appreciate, in response to receiving a search query from a user, a search engine will respond to the query with one or more search results pages. This is interaction is typically done through the use of a browser on the user's computer or computing device. The search results pages include, but are certainly not limited to, a set of search results deemed relevant to the search query. Generally speaking, a search result is a hyperlink referencing content at a target site. The search results in the search results pages are often presented as user-actionable links, commonly displayed in blue to indicate to the user the ability to select (or activate) a link, thereby navigating to the referenced content at the target site. As a search results page will often be constructed to include 10 search results and also due to the blue coloration of the search results, these search results are often referred to as the “10 blue links.” For the sake of clarity, a search result that references content on an entity's site is said to be that entity's search result. For example, a search result referencing content host on Company A's web site is said to be Company A's search result. Similarly, a search result referencing content of a competitor to Company A is said to be the competitor's search result.

Understanding the current query context in which a user navigates (i.e., traverses a hyperlink) to a target site may be very important to site owners. For example, a business (which hosts a target site) may find it highly valuable to know the contextual information in which a user navigates to content on its site. This contextual information may include, but is not limited to, where on a search results page the target site's search result is found; on which search results page (i.e., the first, second, etc.) the target site's search result is found; whether the target site's search result is part of a cluster on the search results page; whether the target site's search result is a paid listing; which advertisements were displayed on the search results page; the relative position of the business's search result with regard to the position of one or more search results of a competitor; the relevance score of the search result to the search query; whether the host is identified as a preferred source of content for the user; user demographics (typically anonymized and/or non-identifying demographics); the type of user device (i.e., mobile smart-phone, laptop, etc.); which browser is used; which search results were selected prior to the selection of the current search result; user and social network preferences; and the like. Of course, it is up to the search engine that generates the search results page to determine what contextual information is passed to a target site. In any event, most if not all of this contextual information can only be determined only at the time that the user navigates to a target site via a hyperlink (such as a search result), especially in light of search results customization/personalization according to user preferences. Aspects of the disclosed subject matter enable delivery of contextual information to a target site in conjunction with user navigation to that target site.

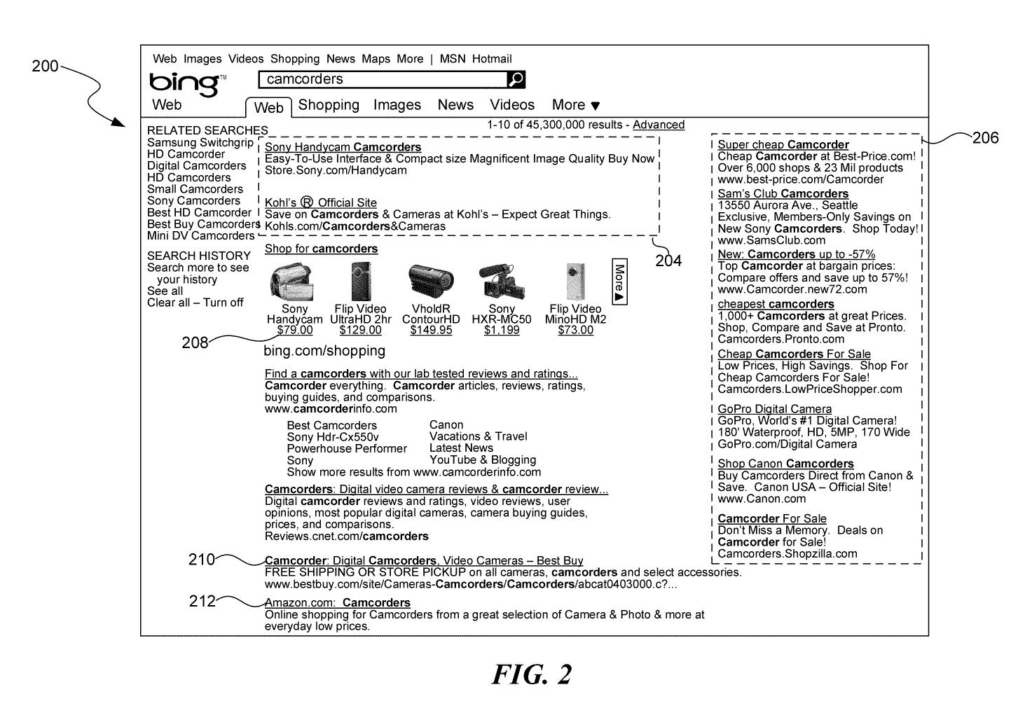

As suggested above, there are “locations” or “positions” with regard to search results that are more important, or desirable, than others. For example, in response to a search query, the first 3 search results presented on a first page of search results are those that are most likely to be selected by a user. Moreover, the search results of a search results page that are initially visible on a user's browser are far more likely to be selected by the user than those results that are on the same search results page but are not initially displayable, i.e., the user must scroll the browser view in order to see the initially un-displayed search results. Further, search results that are included on the first page of search results are far more likely to be selected by the user than those search results that are found on subsequent search results pages. Still further, some search results are “paid” search results where a monetary exchange is made to place the results in a visible position of prominence on a search results page. Examples of paid search results may be seen in regard to FIG. 2. Accordingly, the terms “position” and “location” when used in regard to a search result should be viewed as encompassing, but not limited to, the ordinal number of the search result in the list of search results that are displayed on a search results page, the initial visibility of a search result on a search results page, the search results page number (e.g., the first page, second page, etc.) on which a search result is found, and whether the search result is a paid or unpaid search result.

As used throughout this document, a “source” is an entity that creates, generates, and/or promotes content that can be acted on (often viewed) by a user. Examples of sources include, but are not limited to, a news organization (such as MSNBC or the Huffington Post), an author, a blogger, an organization or association, and the like. A source is distinct from content in that content is originated and/or promoted by the source. In other words, content “flows” from its source. In the context of a search engine responding to a search query, the links/references returned as search results to a search query are links to content, whereas the originator or host of the referenced content is the source of the content. In this regard, a link to an article published by MSNBC on “Syrian protests” is a link to content (the article on Syrian protests) from a source (MSNBC). A “preferred source,” then, is a source that is preferred by a user and an “explicitly preferred source” is a source that has been explicitly identified by a user as a preferred source for that user. For purposes of this document, when referring to a “preferred source” without other modifiers, it is to be assumed that it is a reference to an explicitly preferred source.

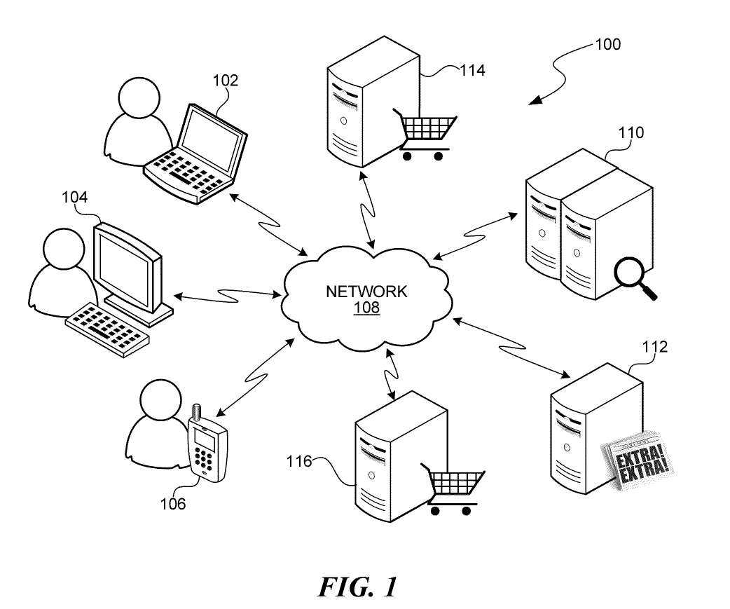

Turning, then, to the figures, FIG. 1 shows a diagram of an illustrative environment 100 in which contextual information can be provided to a target site by way of a search result on a search results page. The illustrative environment 100 includes one or more user computers, such as user computers 102-106, connected to a network 108, such as the Internet, a wide area network or WAN, and the like. Also connected to the network 108 is a search engine 110. Those skilled in the art will appreciate that a search engine 110 corresponds to an online service hosted on one or more computers, or computing systems, distributed throughout the network 108. The search engine 110 receives and responds to search queries over the network 108 from various users, such as the users connected to user computers 102-106. In response to receiving a search query, the search engine 110 identifies relevant content available from various target sites on the network 108 and generates one or more search results pages responsive to the search query. The search engine 110 is shown in FIG. 1 as comprising two computing devices but this is illustrative only.

FIG. 1 further illustrates various target sites connected to the network 108. These target sites include, but are not limited to, news organization 112, and shopping sites 114 and 116. Those skilled in the art will appreciate that any number and type of target sites may be connected to the network and that news and/or shopping sites are simply illustrative. Moreover, as is known in the art, some search engines are aware of millions of target sites and the content that is hosted by these target sites.

Suitable user computers for operating in the illustrative environment 100 include any number of computing devices that can communicate with the search engine 110 over the network 108 in both submitting user queries and receiving a response of search results page from the search engine 110. User computers 102-106 may communicate with the network 108 via wired or wireless communication connections. These user computers 102-106 may include, but are not limited to, laptop computers such as user computer 102, desktop computers such as user computer 104, mobile phone devices such as user computer 106, tablet computers (not shown), on-board computing systems (not shown) such as those found in vehicles, mini- and/or main-frame computers (not shown), and the like.

In response to receiving a search query from a user, a search engine 110 will generate one or more search results pages, each page including a set of search results. According to aspects of the disclosed subject matter, for those target sites that wish to receive contextual information, the search engine 110 will encode data in the target site's search result (or search results) such that the encoded data is delivered to the target site when the user selects/navigates the encoded search result. According to various embodiments of the disclosed subject matter, the encoded data includes the contextual information, provides a means to the target site by which the target site can obtain the contextual information, or a combination of both including contextual information and providing a means (such as a link or identifier) to obtain additional contextual information.

It should be appreciated that one advantages of encoding a search result (particularly the hyperlink) with data for delivering contextual information to a target site is that the search results page can be generated such that the initial appearance of the search result page is indistinguishable from a search results page in which no search results have been encoded. For example, FIG. 2 is an illustrative diagram showing a sample search results page 200 in which some of the search results displayed on the search results page have been encoded with data for delivering contextual information to the corresponding target site. As can be seen, the sample search results page 200 includes two different sections of advertisement, including paid listings 204 (which, in essence, are search results placed in a highly prominent position on a search results page in exchange for monetary compensation) and side rail 206. The search results page 200 further includes a number of search results including search results 208-212. While not initially visible on this page, search results 208-212 have been encoded with data to deliver contextual information to the corresponding target sites.

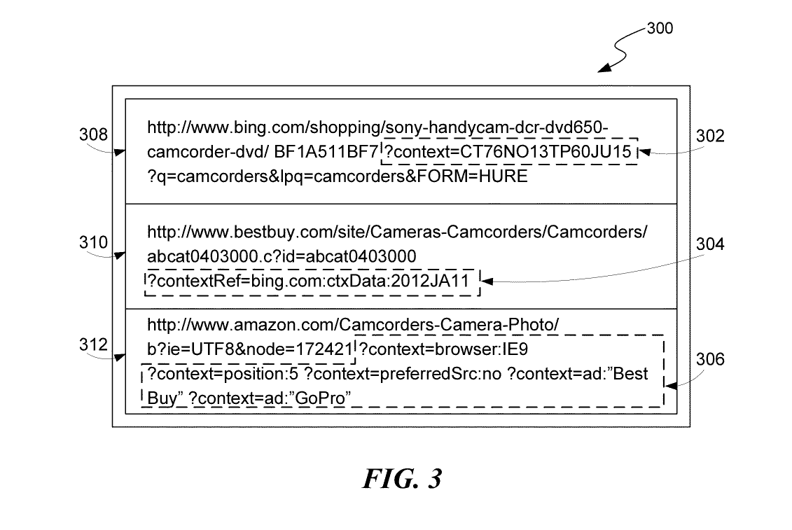

FIG. 3 is a diagram 300 illustrating exemplary encoded search results, 308-312, which for this example correspond to the search results 208-212 of FIG. 2, respectively. In this example, the search results, and in particular the hyperlink portion of the search results, are encoded with data for delivering contextual information to target sites. In regard to hyperlink 308, this exemplary hyperlink includes an encoded section 302 having encrypted and/or compressed data that may be either (1) the contextual information itself or (2) be a reference to the data in an extra location where the target site may obtain the contextual information. Encrypting and compressing data is well known to those skilled in the art. Encrypting and/or compressing data may be viewed as advantageous in regard to encoding data in order to reduce the volume of data that is transmitted to the target site via the user's navigation of the search result 208 and ensuring that the data is accessible only to the target site.

In contrast to hyperlink 308, illustrative hyperlink 310 provides a link, as indicated by encoded section 304, there indicates to the target site the location of the contextual data and an identifier by which the contextual information can be retrieved from the location. In regard to exemplary hyperlink 310, this hyperlink includes a section 306 of unencrypted contextual information.

As suggested above with regard to the data encoded into the search results, the encoded data may comprise a reference to a location (such as a URL) in which the sought-for contextual may be located, an identifier that a target site may use to obtain the contextual information from a known location, the contextual information itself, or any combination of these options. The encoded data may be encrypted such that only the target site has a key to decode and access the data or contextual information. Similarly, the encoded data may be encrypted such that a target site must first pay for a decryption key to access the contextual data. The encoded data may also or alternatively be compressed, thereby reducing the transmission footprint as the user “navigates” to the target site. Data encryption and compression techniques are well known in the art and the disclosed subject matter should be viewed as encompassing the use of these techniques.

While the illustrative search results page 200 of FIG. 2 suggests that only a subset of all search results, such as search results 208-212, are encoded with data for delivering contextual information to target sites, in at least one alternative embodiment all search results on a search results page are encoded with data for delivering contextual information to the corresponding target site. Where a search engine 110 wishes to monetize the delivery of contextual information to target sites and all search results are encoded with data for delivering contextual information, that search engine may employ an encryption technique such that a target size must obtain a decryption key (in exchange for monetary consideration) to access the contextual information, or employee some other type of access restriction to the contextual data.

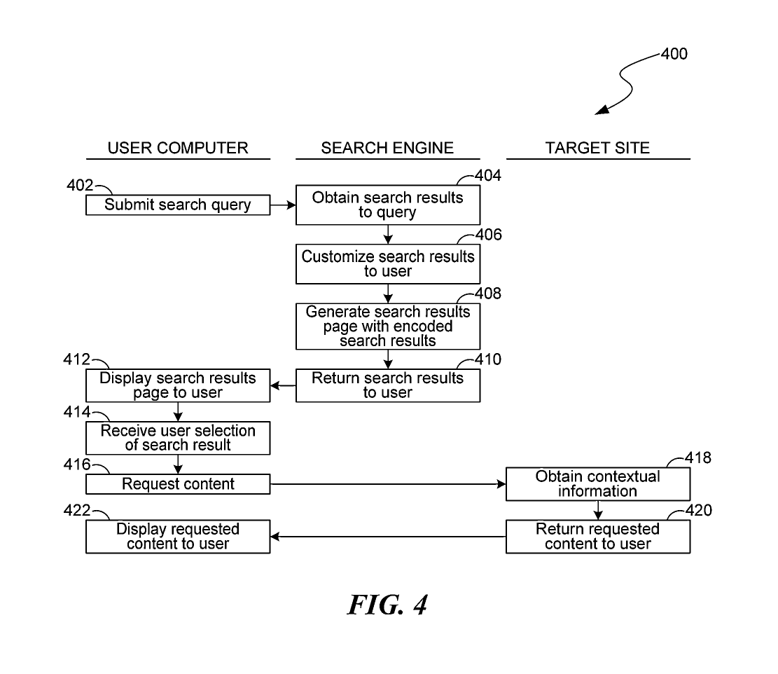

To further illustrate aspects of the disclosed subject matter, FIG. 4 is a state diagram 400 illustrating the interaction between a user via a user computer, the search engine 110, and a target site. Reference is made to a user interacting with user computer 104, and to the shopping site 114 (as the target site of this interaction). Beginning at state 402, the user (via user computer 104) submits a search query to the search engine 110. At state 404, the search engine 110 obtains search results responsive to the user's search query. At state 406, the search results may be personalized to the user according to one or more preferences and/or criteria associated with the user. As suggested above, this personalization results in the rearrangement of the obtained search results. At state 408, the search engine 110 generates at least the first search results page corresponding to the obtained, rearranged set of search results. As part of generating the at least first search results page, the search engine 110 encodes one or more search results with data for conveying contextual information to a corresponding target site 114. At state 410, the search engine 110 returns at least the first search results page (with at least one search result encoded with data for delivering contextual information to the corresponding target site 114) to the user computer 104.

At state 412, the user computer 104 displays the first search results page to the user. FIG. 2, discussed above, is an example of a displayed search results page that was generated by a search engine 110. At state 414, the user computer 104 receives the user's selection of a search result (such as search result 208). At state 416, the user computer “navigates” to the content referenced by the search result 208 by requesting that content from the target site 114. At state 418, in receiving the request for the selected content from the use, the target site 114 also obtains the contextual information surrounding the user's request for the targeted content. As has already been discussed, the encoded data includes the contextual information surrounding the user's request for content, information for obtaining the contextual information surrounding the user's request, or a combination of the two. It should be appreciated that obtaining the contextual information by the target site 114 or a related entity can be carried out asynchronously from delivery of the requested content. Hence, at state 420, the target site 114 returns the requested content to the user computer 104. Finally, at state 422, the user computer 104 displays the content to the user.

Regarding the contextual information delivered to target sites, according to various embodiments of the disclosed subject matter, the contextual content delivered to one target site need not be the same contextual information delivered to another. As already suggested, a target site, such as target site 114, may request contextual information about the position of a competitor's search results relative on its own search results. If follows, then, that at least this information will differ between target sites. Similarly, according to various embodiments of the disclosed subject matter, a target site could specify which contextual information that is requested. On the other hand, a search engine 110 could be configured to encode the search results such that the same contextual information is delivered to each target site. Moreover, for that information that is specific to one target site, this information could be determined in an asynchronous manner, after a user has “navigated” to content on its site.

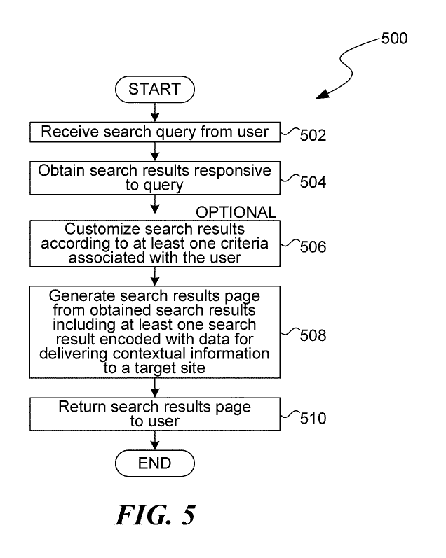

Turning now to FIG. 5, FIG. 5 shows a flow diagram 500, as executed on a search engine 110, for providing a search results page responsive to a search query from a user, the search results page including at least one search result encoded with data for providing contextual information to a corresponding target site. Beginning at block 502, the search engine 110 receives a search query from a user (via the user's computer over the network 108.) At block 504, in response to the search query, the search engine 110 obtains a set of search results relevant to the query. As already mentioned, the search results are comprised of references (or hyperlinks) to content available throughout various target sites on the network 108.

At block 506, the search engine 110 optionally personalizes the obtained search results according to one or more preference criteria associated with the user. By way of example, these criteria may include, but are not limited to, browsing history, purchase history, preferred sources for content, social network preferences, and the like. Personalizing (or customizing) the search results according to preference criteria associated with the user has the effect of reordering, or rearranging, the set of search results. With personalization, some search results that would have not otherwise been displayed prominently to the user (i.e., on the first search results page and/or within the first few positions on that search results page) would be displayed in those prominent positions; and other search results that would have been displayed prominently to the user may be moved out of the prominent positions.

At block 508, the search engine 110 generates at least a first search results page from the set of search results (optionally rearranged due to the personalization). This search results page includes at least one search result that is encoded with data for providing contextual information regarding the present search results page to the corresponding target site. At block 510, after having generated the search results page, the search engine 110 returns the first search results page to the user (via the user's computer) in response to the search query. Thereafter, the routine 500 terminates.

Regarding FIG. 5, it should be appreciated that while routine 500 is expressed with discrete steps, these steps should be viewed as being logical in nature and may or may not correspond to any actual, discrete steps. Nor should the order that these steps are presented be construed as the only order in which the various steps may be carried out. Those skilled in the art will appreciate that logical steps may be combined together or be comprised of multiple steps. Further, while novel aspects of the disclosed subject matter are expressed in routines or methods, this functionality may also be embodied in computer-readable media. As those skilled in the art will appreciate, computer-readable media can host computer-executable instructions for later retrieval and execution. When executed on a computing device, the computer-executable instructions carry out various steps or methods. Examples of computer-readable media include, but are not limited to: optical storage media such as digital video discs (DVDs) and compact discs (CDs); magnetic storage media including hard disk drives, floppy disks, magnetic tape, and the like; transitory and non-transitory memory such as random access memory (RAM), read-only memory (ROM), memory cards, thumb drives, and the like; cloud storage (i.e., an online storage service); and the like. For purposes of this document, however, computer-readable media expressly excludes carrier waves and propagated signals.

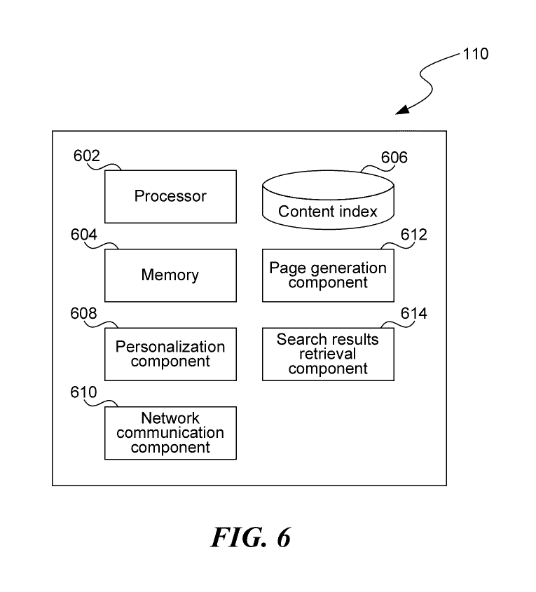

Turning now to the search engine 110, FIG. 6 is a block diagram illustrating a search engine 110 for providing search results encoded with data for providing contextual information surrounding the current query context of the user to target sites. The search engine 110 includes a processor 602 and a memory 604. As those skilled in the art will appreciate, the processor 602 executes instructions retrieved from memory 604 in carrying out various aspects of the hosted search service, including encoding search results with data for providing contextual information of the user's current search context to target sites.

The search engine 110 also includes a network communications component 610 through which the search engine sends and receives communications over the network 108. For example, it is through the network communication component 610 that the search engine 110 receives search queries from user computers, such as user computers 102-106, and returns results responsive to the search queries. The search engine 110 further includes a search results retrieval component 614, a personalization component 608, a content index 606, and a page generation component 612. It should be appreciated, of course, that these additional components should be viewed as logical components for carrying out various functions of suitable configured search engine 110. These logical components may or may not correspond directly to actual components. Moreover, in an actual embodiment, these components may be combined together or broke up across multiple actual components.

Regarding the search results retrieval component 614, this logical component is responsible for retrieving or obtaining search results relevant to a user's search query from the content index 606. Once the set of search results responsive to a search query have been retrieved, the personalization component 608 is responsible for personalizing the set of search results according to one or more personalization criteria associated with the user. As mentioned previously, the effect of personalization is that the order of search results within the set of search results is rearranged.

The page generation component 612 is responsible for generating at least one search results page from the rearranged set of search results. As part of generating the search results pages, the page generation component 612 is also responsible for encoding the search results with data for providing contextual information to the corresponding target site. Once search results pages have been generated, at least one of the pages is returned to the user (via the user's computer) over the network communication component 610.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for generating a search results page that provides contextual information of a user's current query context to a target site associated with a search result, the method comprising:
obtaining a set of search results responsive to a search query from a user, each search result in the set of search results comprising a hyperlink to content at a corresponding target site;
generating a search results page from the set of identified search results, wherein at least one search result in the search results page is encoded with data for providing contextual information of the user's current query context, such that the encoded data is delivered to the corresponding target site upon the user's selection of the at least one search result; and
providing the generated search results page for display in response to the search query.

2. The computer-implemented method of claim 1, wherein the contextual information comprises the position of the at least one search result in the search results page.

3. The computer-implemented method of claim 2, wherein the contextual information comprises one or more criteria indicating the basis for the position of the at least one search result in the search results page.

4. The computer-implemented method of claim 1, wherein the contextual information comprises an indication that the target site is a preferred source of the user.

5. The computer-implemented method of claim 1, wherein the contextual information comprises a relevance score of the at least one search result to the search query.

6. The computer-implemented method of claim 1, wherein the contextual information comprises the position of the at least one search result in the search results page relative to the position of another search result in the search results page, the another search result referencing content of a competing target site.

7. The computer-implemented method of claim 1, wherein the contextual information comprises one or more demographics of the user.

8. The computer-implemented method of claim 1, wherein the contextual information comprises an identification of one or more advertisements displayed on the search results page with the at least one search result.

9. The computer-implemented method of claim 1, further comprising personalizing the set of search results according to at least one preference of the user.

10. The computer-implemented method of claim 1 further comprising:
receiving a user selection of the at least one search result; and
delivering the encoded data for providing contextual information of the user's current query context to the target site.

11. A computer-implemented system for providing contextual information to a target site upon the selection of a search result referencing content hosted by the target site, the system comprising:
a processor, a memory, and a network communication component, wherein the processor executes instructions stored in the memory as part of or in conjunction with additional components to respond to a search query, wherein the system is configured to:
obtain a set of search results responsive to receiving a search query from a user, each search result in the set of search results comprising a hyperlink to content at a target site;
personalize the set of search results according to the at least one preference of the user resulting in a rearranged set of search results;
generate a search results page from the rearranged set of search results, wherein at least one search result in the search results page is encoded with data for providing contextual information of the user's current query context to the corresponding target site upon user selection of the at least one search result; and
provide the generated search results page for presentation to the user in response to the search query.

12. The computer-implemented system of claim 11, wherein the contextual information comprises the location of the at least one search result in the search results page.

13. The computer-implemented system of claim 12, wherein the contextual information comprises one or more criteria indicating the basis for the location of the at least one search result in the search results page.

14. The computer-implemented system of claim 11, wherein the contextual information comprises at least one of:
an indication that the target source is a preferred source of the user;
a relevance score of the at least one search result to the search query;
the location of the at least one search result in the search results page relative to the location of another search result in the search results page, the another search result referencing content of a competing source;
the user query;
one or more demographics of the user; and
an identification of one or more advertisements displayed on the search results page with the at least one search result.

15. A computer-readable medium bearing computer-executable instructions which, when executed on a computer system comprising at least a processor and a memory, carry out a method for generating a search results page that includes at least one search result that provides contextual information of the user's current query context to a target site associated with a search result, the method comprising:
obtaining a set of search results responsive to receiving a search query from a user, each search result in the set of search results comprising a hyperlink to content at a target site;
personalizing the order of the search results according to the at least one preference of the user;
generating a search results page from the personalized set of search results including at least one search result in the search results page that is encoded with data for providing contextual information of the user's current query context to the target site such that the encoded data is delivered to the corresponding target site upon user selection of the at least one search result; and
providing the generated search results page to the user in response to the search query.

16. The computer-readable medium of claim 15, wherein the encoded data for providing contextual information of the user's current query context to the target site comprises an identifier by which the target site can asynchronously obtain the contextual information.

17. The computer-readable medium of claim 15, wherein the method further comprises creating a monetary charge against the corresponding target source in exchange for encoding the at least one search result with data for providing the contextual information of the user's current query context to the target site.

18. The computer-readable medium of claim 15, wherein the contextual information comprises the location of the at least one search result in the search results page.

19. The computer-readable medium of claim 15, wherein the contextual information comprises one or more criteria indicating the basis for the location of the at least one search result in the search results page.

20. The computer-readable medium of claim 15, wherein the contextual information comprises at least one of:
an indication that the target site is a preferred source of the user;
a relevance score of the at least one search result to the search query;
the location of the at least one search result in the search results page relative to the location of another search result in the search results page, the another search result referencing content of a competing source;
one or more demographics of the user; and
an identification of one or more advertisements displayed on the search results page with the at least one search result.
